(19) United States
(12) Patent Application Publication
(10) Pub. No.: US 2003/0233323 A1
(43) Pub. Date: Dec. 18, 2003

(54) Capped bill systems, methods and products having an insurance component

(76) Inventors: Bernie Bilski, Pittsburgh, PA (US); Teresa Kishlock, Murrysville, PA (US); Laura Lewis, Irwin, PA (US); Jim McLaughlin, Pittsburgh, PA (US); Vijay Parmar, Pittsburgh, PA (US); Rand Warsaw, Monroeville, PA (US)

Correspondence Address: KIRKPATRICK & LOCKHART LLP, 535 SMITHFIELD STREET, PITTSBURGH, PA, 15222, US

(21) Appl. No.: 10/400,846

(22) Filed: Mar. 27, 2003

Related U.S. Application Data
(63) Continuation-in-part of application No. 10/108,089, filed on Mar. 27, 2002.

(51) Int. Cl. G06F 17/60

(52) U.S. Cl. 705/40; 705/38; 705/4

(57) ABSTRACT

A method of providing one of a good or a service to at least one entity at one of a payment, rate, or price that is capped at a pre-determined amount. The method includes producing an offer for the entity, wherein the offer represents one of a capped maximum payment, a capped maximum rate, or a capped maximum price amount and receiving an insurance premium. The method also includes providing the good or service to the entity at one of a payment, rate, or price that may fluctuate, wherein the payment, rate, or price cannot exceed the capped maximum payment, capped maximum rate, or capped maximum price amount and paying an insurance proceed when an actual price of the good or service exceeds the capped maximum payment, capped maximum rate, or capped maximum price amount.

### CROSS REFERENCE TO RELATED APPLICATION

This application is a continuation-in-part of U.S. application Ser. No. 10/108,089 filed Mar. 27, 2002.

### DESCRIPTION OF THE BACKGROUND

Currently, only large consumers are able to get the benefits of traditional financial risk management tools for managing their costs for variable volumes and prices of products and services because of the labor-intensive analysis of risk performed on a manual basis, because of regulations restricting the offering of some financial risk management instruments to only large and sophisticated investors and because the size and cost of available financial instruments may not be appropriate for individual consumer risk management.

Further, it has not been cost effective to perform the analyses necessary to control volume and price risks for retail consumers such as individual residential or small- to medium-sized commercial customers. The high cost of individual analyses is driven by the need to manually process dependent and independent variable data, individually deal with data deficiencies and to make manual adjustments for incomplete or inaccurate information.

Current methods and products exist to provide consumers that seek to limit consumer risk in purchasing variable payment products. Examples include capped adjustable rate mortgages, fixed payment plans, flat payment plans, the No Surprise™ Bill^{SM} program offered by Reliant Centerpoint Energy/Minnegasco, the WeatherProof® Bill program offered by several licensees of the energy risk management method described in U.S. patent application Ser. No. 08/833,892.

### SUMMARY OF THE INVENTION

The present invention is directed to, in one embodiment, a method of providing one of a good or a service to at least one entity at one of a payment, rate, or price that is capped at a pre-determined amount. The method includes producing an offer for the entity, wherein the offer represents one of a capped maximum payment, a capped maximum rate, or a capped maximum price amount and receiving an insurance premium. The method also includes providing the good or service to the entity at one of a payment, rate, or price that may fluctuate, wherein the payment, rate, or price cannot exceed the capped maximum payment, capped maximum rate, or capped maximum price amount and paying an insurance proceed when an actual price of the good or service exceeds the capped maximum payment, capped maximum rate, or capped maximum price amount.

The present invention is also directed to, in another embodiment, a capped bill calculation system. The system includes a data input module in communication with a data storage medium for receiving data from at least one entity. The system also includes a capped bill offer generation module for generating an offer, wherein the offer offers one of a good or a service at one of a payment, rate, and price that may fluctuate, wherein one of an actual payment, actual rate, and actual price of the good or service cannot exceed one of a maximum payment, a maximum rate, and a maximum price amount, and wherein the offer takes into account an insurance premium for insurance that is used to cover at least a portion of a difference between one of the maximum payment, the maximum rate, and the maximum price amount and one of the actual payment, the actual rate, and the actual price of the good or service when one of the actual payment, the actual rate, and the actual price of the good or service exceeds one of the maximum payment, the maximum rate, and the actual price amount.

### BRIEF DESCRIPTION OF THE DRAWING

For the present invention to be clearly understood and readily practiced, the present invention will be described in conjunction with the following figures, wherein:

FIG. 1 is a diagram illustrating a flow through a capped bill calculation system according to one embodiment of the present invention;

FIG. 2 is a diagram of a capped bill calculation system according to one embodiment of the present invention;

FIG. 3 is a flow diagram illustrating a method of producing a fixed unit energy price for use in calculating a capped energy bill according to one embodiment of the present invention; and

FIGS. 4 and 5 are examples of cash flows between consumers and risk management instruments according to one embodiment of the present invention.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, other elements. For example, specific operating system details and modules and specific database management details and modules are not shown. Those of ordinary skill in the art will recognize that other elements may be desirable to produce an operational system incorporating the present invention. However, because such elements are well known in the art, and because they do not facilitate a better understanding of the present invention, a discussion of such elements is not provided herein.

The present invention is directed generally to systems and methods in which goods or services are delivered and the customer or consumer (or other entities) is invoiced for a payment or series of payments that are capped. “Capped” is defined herein as meaning a quoted maximum amount or amounts that the customer will pay for their requirements for a product or service for the given period or periods of time. Several examples of such products or services include, but are not limited to, energy bills, communications services, food supply, network services, calculational services, storage space, transportation, fuel, auto leasing, maintenance, or mortgages. Energy and mortgage examples are used herein for the sake of illustration purposes only and not to limit the scope of the invention.

In one embodiment of the present invention, if the combined effect of drivers of the consumer cost, such as prices and volumes of, for example, energy delivery or interest rates would have resulted in lower bills than the capped amount or amounts less risk management costs, the entity, such as a customer, receives all or a portion of the difference as, for example, a refund or credit. Also, in one embodiment, a system for calculating a capped or maximum annual bill for any consumers of a product or service, for managing the risks associated with the capped annual bill, and for reporting the accounting aspects of the transactions to those consumers and to other interested parties such as utilities, energy suppliers, regulators and other governmental agencies is disclosed. Also, in another embodiment, a specific method of producing capped bills, and using physical and/or financial instruments to hedge the volumes and prices of the product or service to be used is disclosed.

The present invention is directed, in one embodiment, to a method of receiving, processing and reporting data regarding retail consumers' usage of a product or service and historic non-customer specific independent variable data in large batches of consumers for the purposes of providing offerings of a capped bill to those consumers and managing the volume and price risks associated with each consumer who accepts the commercial offer. The present invention, in one embodiment, utilizes a system that produces mass-customized offers through multiple stages.

Generally, the first stage of the present invention, in one embodiment, processes both customer-specific dependent and independent variable data and non-customer-specific independent variable data for a group of consumers. In the case of a capped energy bill, the customer-specific dependent variable data could include, for example, historic usage, demand levels and dollars billed. In the case of a mortgage borrowing, the customer-specific dependent variable data could include, for example, the amount borrowed, term of the agreement and related credit risk. A variable such as historic usage may be both independent and dependent. For example, historic usage data are dependent in that they are a function of historic weather. Historic usage is used as an independent variable when calculating dollars billed. For each group of customer-specific dependent variable data to be processed, accurate historic non-customer specific independent variable data may be acquired. In the case of an energy capped bill, the independent data may include, for example, heating degree days, cooling degree days, relative humidity, dew point, atmospheric pressure and precipitation. In the case of a mortgage capped bill, the independent variable data may include, for example, historic interest rates, forward rates and rates currently available. These data may be transmitted over a communication link such as, for example, the Internet, telephone lines or by computer readable media such as, for example, magnetic or optical storage media. Distribution can also be accomplished by distribution to a central storage site on the public Internet, an intranet, a local area network (LAN), a wide area network (WAN) or a direct connection for further access or distribution.

Both the customer-specific and the non-customer-specific dependent and independent variable data received may be missing some data points or contain gross inaccuracies. The present invention, in one embodiment, detects missing or grossly inaccurate data points and correctly “fills” the data using a variety of algorithms including, but not limited to, regressions, average replacements, deltas off of adjacent weather stations in the case of an energy capped bill, deltas off of prior points, average prior and subsequent point and strategic estimates.

Each batch of usage data to be processed includes electronic data regarding anywhere from, for example, a few dozen to several million individual retail consumers. In the case of a capped energy bill, for each consumer data regarding, for example, up to 24 months of usage is included. Data for each usage period for each consumer may include individual consumer record keys such as account number, sufficient location information to identify the appropriate weather station, consumption information including meter read data and dates, type of meter read which may include actual, estimate, correction and other billing information. In addition, contact information such as name, address and phone number may be included for reporting purposes.

In the case of an energy capped bill, the energy usage data (consumption in volumes of fuel such as, for example, gallons, MCF's, and pounds, etc., or energy units such as, for example, kWh, therms, BTU's, etc.) with related information about the periods of consumption such as starting date and number of days in a period, ending date and number of days in a period, starting and ending dates or a series of days in a period with a beginning or ending offset sufficient to determine the starting and ending dates of each consumption period received from, for example, the utility or energy supplier, may contain known data structure problems such as overlapping or missing meter read periods, invalid dates, such as February 30, invalid years such as 1901 appearing in a data set containing 2001 data, bad estimates, bad meter reads and accounting corrections, including those previously mentioned, and cancels and rebills. The present invention, in one embodiment, examines the data for these and other problems and repairs or removes problematic data elements using a variety of algorithms including, but not limited to, artificial intelligence, regression technology, analysis of variance, outlier analysis and human inspection.

The second stage of the present invention, in one embodiment, builds a model of how each individual consumer consumes the product or service with respect to the independent variables such as, for example, weather or interest rates. The model may be built specifically for that consumer. In the case of an energy capped bill, the present invention, in one embodiment, examines the cleaned data for a baseline period and develops individual mathematical baseline models representing usage patterns for each consumer. The models may include, but are not required to use, or limited to, the analysis of base non-weather related use, usage sensitivity to changes in weather, temperatures at which the consumer turns on or off their heating and/or cooling systems, humidity, precipitation, wind speed, cloud cover and trend variables. For large consumers of energy, time and effort may be taken to produce a customized model of behavior. For small consumers, there have been some attempts at automated energy consumption model generation, such as the Prism approach, described in Fels, M., “PRISM: An Introduction”, Energy and Buildings, 9 (1986), pp. 5-18. The present invention, however, provides a method of automated model generation for a large number of individual consumers and a method of aggregating the individual models into response curves suitable for price and volume risk management.

The third stage of the present invention, in one embodiment, uses the individual models to produce a profile of individual levels of dependent variables with respect to differing states of the independent variables for a group of consumers that statistically represent the type and weighting of consumers who are likely to accept the capped bill offering. In the case of an energy capped bill, producing this calculation at various customer counts will provide the range of weather-related consumption in which to price hedge. In the case of borrowing, this calculation at various customer counts will provide a range of interest related risk in which to hedge. Financial or physical, in the case of energy, options and swaps can be used to fix unit price over the range. Having a fixed unit price as an input to a later calculation may be desirable. Thus, a fixed unit price, prices or interest rates to be used may be assumed.

The fourth stage of the present invention, in one embodiment, constructs a model of consumer risk related to the non-customer specific independent variables at the assumed prices used in the second stage. For example, in the case of an energy capped bill, weather risk may be simulated by using the range of weather conditions historically found or by using an assumed range of likely weather conditions to drive the individual consumer models. In the case of borrowing, interest rate risk may be simulated by using the range of interest rates historically found or by using an assumed range of likely interest rates to drive the individual consumer models. The results are either aggregated into response curves or calculated individually. Risk management is also performed.

The fifth stage of the present invention, in one embodiment, uses the individual models in conjunction with risk management calculations to produce individual offers for the capped bills. These offers may be based on a normalized consumption plus program fees (or program insurance premiums) and risk management costs. In the case of capped energy bills, this could be consumption normalized based on weather. In the case of borrowing, this could be lending calculations based on prevailing interest rates, term of loan and risk management costs. They may also be based on value at risk methodology.

The duration of the capped bill program term may be, for example, a month, a quarter, a year, a multi-year period or any other time period specified by the program terms such as, for example, a heating season from October-May or a cooling season from June-August. The program term may consist of one or more capped bill periods. A customer's bill amount may be capped at a different amount during each period or may be flattened to one capped bill amount for each capped bill period. Averaging or time value of money calculations may be performed to produce a constant cap over each period or across multiple periods.

The sixth stage of the present invention, in one embodiment, tracks the consumption and price over the program to calculate what refunds, if any, are due. In the case of a capped energy bill, in each capped bill period, if weather and price changes would have resulted in a lower actual consumer bill, then all or a portion of those savings may be refunded to the consumer in any one of numerous business scenarios. In the case of borrowing, if actual interest rates would have resulted in a lower payment or shorter term, then all or a portion of those savings may be refunded to the customer or used to reduce the principal amount of the loan. The refund may occur in one or more settlement periods during the capped bill program or after the capped bill program. An example of refund generation can be seen if, for each capped bill period, the amount calculated by subtracting the total actual bill amounts during the period from the total capped bill amounts during the period exceeds the consumer's hedging costs and program fees. The excess amount is considered the bill difference. Individual bill differences may be accrued during settlement periods, which may consist of one or more of the capped bill periods. In one embodiment, for example, the refund or a portion of the refund may be made to a third party such as a utility or aggregator that has outstanding receivables from the consumers. In one embodiment, the consumer may be unaware that they are participating in a capped bill program.

If the bill difference is positive, the amount of the bill difference multiplied by the credit percentage is the credit amount. The credit percentage ranges from 0% to 100% and represents the percentage of the bill difference that will be credited to the customer. The credit amount may be, for example, credited to the customer at the end of each capped bill period, may be accumulated and credited to the customer at the end of the capped bill program or may be accumulated and credited to the customer on any schedule specified in the capped bill program contract.

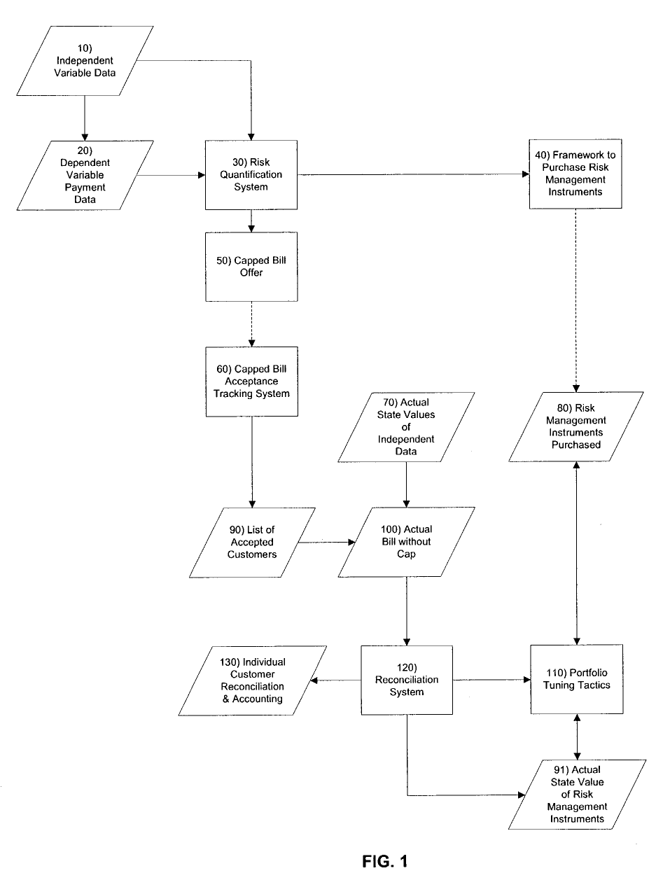

FIG. 1 is a diagram illustrating a flow through a capped bill calculation system according to one embodiment of the present invention. Dependent variable payment data 20 are input into a risk quantification system 30. The dependent variable data 20 may be, for example, a variable payment amount in a mortgage or lending calculation or a variable utility bill. The dependent variable data 20 are dependent on independent variable data 10. In a mortgage example, the independent variable data 10 include, for example, the principal amount borrowed, real estate and/or school taxes escrowed, an interest rate and a number of periods. In an energy bill example, the independent variable data 10 include, for example, weather, metered consumption (which is dependent on weather and personal usage patterns), price and other variables such as taxes and other charges. The risk quantification system 30 produces two or more sets of values using historic or inferred states of independent variables. The first set of values is the level of cap or caps appropriate for a capped bill offer 50. The second set of values is a framework in which to purchase risk management instruments 40 in which to control the risk from a capped bill program. In the broadest sense, the risk quantification system 30 could be, for example, an educated estimate of a value that is deemed by some individual as appropriate for the customer. The risk management framework 40 may be the absorption of the risk implicitly by the offeror.

The capped bill offer 50 is made to consumers. The offer 50 may be structured so that the maximum amount to be paid by the consumer over the term of the offer 50 is the consumer's initial agreed upon payment amount. Should conditions (e.g., interest rate in mortgages or weather and or energy unit prices in energy) change such that certain commercial conditions in the offer to consumers 50 are triggered, the consumer would be contractually entitled to a partial or complete refund from the amount that had been paid by the customer. This differs from a capped adjustable rate mortgage in that for the consumer of an adjustable-rate mortgage, the interest rate level and periodic repayment amount for the mortgage may increase or decrease from the interest rate and periodic repayment amount that was agreed upon when the mortgage loan was taken by the consumer but will not exceed a maximum interest rate or periodic repayment amount, whereas in the present invention, the periodic payment or repayments represent the maximum interest rate and/or maximum periodic repayment amount for that mortgage. If current interest rates are lower than those rates used to calculate the capped mortgage amount at the origination of the mortgage, then one or more of several things could occur, such as the periodic repayment amount could be reduced or the principal amount of the mortgage could be reduced or the amount of excess payment could be refunded to the borrower.

The capped bill is different from an insurance policy that refunds premiums after a number of periods in several ways. For example, an insurance policy anticipates a very long cycle and is based on low probability high impact events, whereas the capped bill is based on consumption of services or goods over performance periods that are anticipated to be continuing onward in time. However, each performance period is individually calculated or priced with respect to current rates. The risk management for a capped bill is applied to individual capped periods without respect to other consumers or entities in the pool, whereas in an insurance policy, risk management is pooled on an actuarial basis and refunds are designed to return a portion of the premium based on the individual claims history. The actuarial nature of an insurance policy counts on premium revenues exceeding benefits paid and the ability of the insurance company to invest the premiums to generate income. In the capped bill, it would not be unusual for all consumers or a majority of the consumers to receive refunds during the same capped bill period.

A capped bill acceptance tracking system 60 is used to keep track of capped bill offers 50 that have been made, and to keep track of subsequent acceptances. The capped bill acceptance tracking system 60 produces a list of accepted customers 90. In its simplest form, the capped bill tracking system 60 could be a pencil and paper-produced list.

The risk management instruments purchased 80 may be purchased using the framework to purchase risk management instruments 40. Optionally, they may be adjusted by human decisions or completely excluded if the offeror of capped bill offers 50 chooses to absorb the risk or a portion of the risk.

During the performance period state of the independent data, actual values of independent data 70 drive the values calculated by the reconciliation system 120 of the actual bill without cap 100, and the value of each of the financial instruments purchased to reduce the risk 80. The reconciliation system 120 provides individual customer reconciliations with respect to the independent variables as well as calculating the actual state value of risk management instruments 91 used to provide portfolio tuning tactics 110 as to tuning the risk management instruments purchased 80 by buying more or selling some of the existing instruments. In one embodiment of the invention, instrument tuning is not required to be done if an offeror is self-absorbing the risks. Individual reconciliation 130 may be required to provide refunds if any are contractually due.

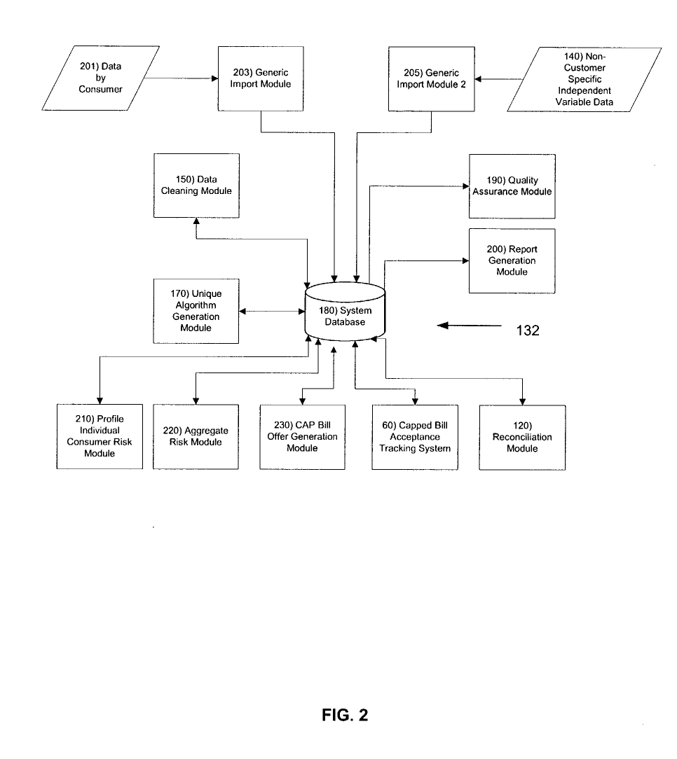

FIG. 2 is a diagram of a capped bill calculation system 132 according to one embodiment of the present invention. Data by consumer 201 contained within a database for individual consumers or provided by individual consumers are transmitted over a communication link such as, for example, the Internet, telephone lines or by computer readable media such as, for example, magnetic or optical storage media. Distribution can also be accomplished by distribution to a central storage site on, for example, the public Internet, an intranet, a local area network (LAN), a wide area network (WAN) or a direct connection for further access or distribution. Alternatively, data can be transmitted verbally and transcribed or keyed into the generic import module 203. Data for consumers 201 may include individual consumer record keys such as, for example, account number, and independent variable values, (e.g. consumption information including meter read data and dates, type of meter read which may include actual, estimate, correction and other billing information in the case of energy bills, principal amount borrowed, interest rate, credit risk and term in the case of borrowing). An alternate method would be to provide summaries of individual statistics grouped by zip code, income level, by square footage of home, or other demographic variables in order to provide capped bill offers to groups of similar customers. In addition, contact information such as name, address and phone number may be included for a report generation module 200 and the capped bill acceptance tracking system 60. Additional information may be required such as conversion factors from energy units to alternate energy units or dollars or forward expected interest rates. This data transmission may occur at one time or many times throughout the process.

Generic import module 203 accepts the data by consumer 201 and imports the data into the appropriate positions in a System Database 180.

Data cleaning module 150 examines the data for known data structure problems (e.g. overlapping meter read periods, invalid dates, bad estimates, bad meter reads and accounting corrections) and cancels and rebills in the case of energy capped bills. In addition, the data cleaning module 150 repairs or removes problematic data elements.

Non-customer-specific independent variable data 140 are transmitted over a communication link such as, for example, the Internet, telephone lines or by computer readable media such as, for example, magnetic or optical storage media. Distribution can also be accomplished by distribution to a central storage site on, for example, the public Internet, an intranet, a local area network (LAN), a wide area network (WAN) or a direct connection for further access or distribution. Alternatively, data can be transmitted verbally and transcribed or keyed into the generic import module 205. Non-customer-specific independent variable data 140 may include, for example, heating degree days, cooling degree days, relative humidity, dew point, atmospheric pressure, precipitation, wind speed and cloud cover percentage in the case of energy capped bills or interest rates in the case of borrowing capped bills.

Generic import module 205 accepts the non-customer-specific independent variable data 140 and imports them into appropriate positions in the system database 180.

Data cleaning module 150 examines the data for known data structure problems such as invalid values or missing data. In one embodiment, the present invention fills missing data points using methods which may include, for example, averaging, regression, interpolation between neighboring weather stations, application of normals and application of known biases to data from neighboring stations.

Unique algorithm generation module 170 examines the cleaned data for a base period and develops individual mathematical baseline models (the models may be, in some instances, the same for a group of customers) representing response patterns for each consumer with respect to the non-customer-specific independent variables. Each model, in the case of energy capped bills, may include an analysis of, for example, base non-weather related use, usage sensitive to changes in weather, temperatures at which the consumer turns on or off their heating and/or cooling systems and trend variables. In the case of borrowing, the model may include an analysis of, for example, principal amount borrowed, credit criteria, historic interest rates, forward interest rates and term. The algorithms generated by the algorithm generation module 170 may be, for example, stored in the system database 180 or may be used immediately in other modules without storage.

Profile individual consumer risk module 210 exercises the baseline model for each consumer over a variety of states of the non-customer specific independent variables 140 that represent the total risk space. These states can be generated by, for example, simulating past variable states or choosing states from distributions manufactured by examining past states or manufactured using other statistical methods. In the case of an energy capped bill, one method of accomplishing this would be to use actual weather data that occurred in a period subsequent or prior to the base period to determine an estimate of each consumer's expected consumption at different temperatures.

The profile individual consumer risk module 210 converts the results to a response function or set of functions of dependent variable states with respect to the non-customer specific independent variables. These response functions may be, for example, stored within the system database 180 or used immediately by other modules.

The aggregate risk module 220 converts the response functions for groups of individual consumers into a set of aggregate response curves. The curves may be, for example, stored within system database 180 or used immediately by other modules.

The aggregate curves generated by the aggregate risk module 220 are used to generate a framework used to design a strategy and to price and purchase risk management instruments 40. FIG. 2 illustrates a manual decision-making process to determine the strategy and related cost of the strategy. The cost of these instruments and other pricing variables are used in conjunction with the profile individual consumer risk models to generate capped bill offers for consumers in the capped bill offer generation module 230. These offers may be, for example, stored within the system database 180 for later use or transmitted directly to the customers.

Quality assurance module 190 executes methods of quality control to assure the accuracy of calculations and output. The module 190 randomly pulls a sample of individual calculations to be compared to a hand calculation performed by the system operator or parallel operation performed by a second system. In addition, issues that are missed in the data cleanup may be determined at this stage. A system of prescribed reality checks using tests of known ratio ranges also are used to detect problems with modeling or data cleaning. This step is important in establishing credibility with consumers and other interested parties such as regulators, legislators lending institutions and utilities. Module 190 also ensures that each input record is accounted for and ensures data integrity through the report generation module 200. Individual capped bill offers may be, for example, transmitted through the report generation module 200 to individual consumers or delivered in bulk to interested parties such as lending institutions or utilities. Such delivery may be transmitted over a communication link such as, for example, the Internet, telephone lines or by computer readable media such as, for example, magnetic or optical storage media. Distribution can also be accomplished by, for example, distribution to a central storage site on the public Internet, an intranet, a local area network (LAN), a wide area network (WAN) or a direct connection for further access or distribution. Alternatively, data can be transmitted verbally or through carrier delivery.

The capped bill acceptance tracking system 60 keeps track of acceptances which may be transmitted by individual consumers or delivered in bulk from interested parties such as lending institutions or utilities or third party marketing vendors. Such transmittal may be over a communication link such as, for example, the Internet, telephone lines or by computer readable media such as, for example, magnetic or optical storage media. Transmittal can also be accomplished by, for example, distribution to a central storage site on the public Internet, an intranet, a local area network (LAN), a wide area network (WAN) or a direct connection for further access or distribution. Alternatively, data can be transmitted verbally or through carrier delivery.

The report generation module 200 can be used to deliver capped bill quotes 50 directly to consumers and can be used to deliver individual easy-to-understand reports regarding potential or actual refunds produced by reconciliation module 120. Also provided by the report generation module 200 are program overviews provided to interested parties such as, for example, lending institutions, utilities, and regulators to understand the status of the program on an aggregate basis, resolve issues regarding individual consumer accounts, and to program management staff for purposes of tuning the risk management portfolio.

The reconciliation module 120 tracks the non-customer-specific independent variables 140 with respect to each accepted capped bill offer 50 to determine the status of individual refunds that may be due. Information from the reconciliation module 120 on an individual consumer's account is disseminated through the report generation module 200. In addition, the reconciliation module 120 keeps track of the status of instruments in the risk management portfolio to produce an aggregate view of current status of the program as a whole. This is reported through the report generation module 200 in the form of, for example, a portfolio tuning report. Risk strategies may be adjusted by selling or buying additional risk management instruments.

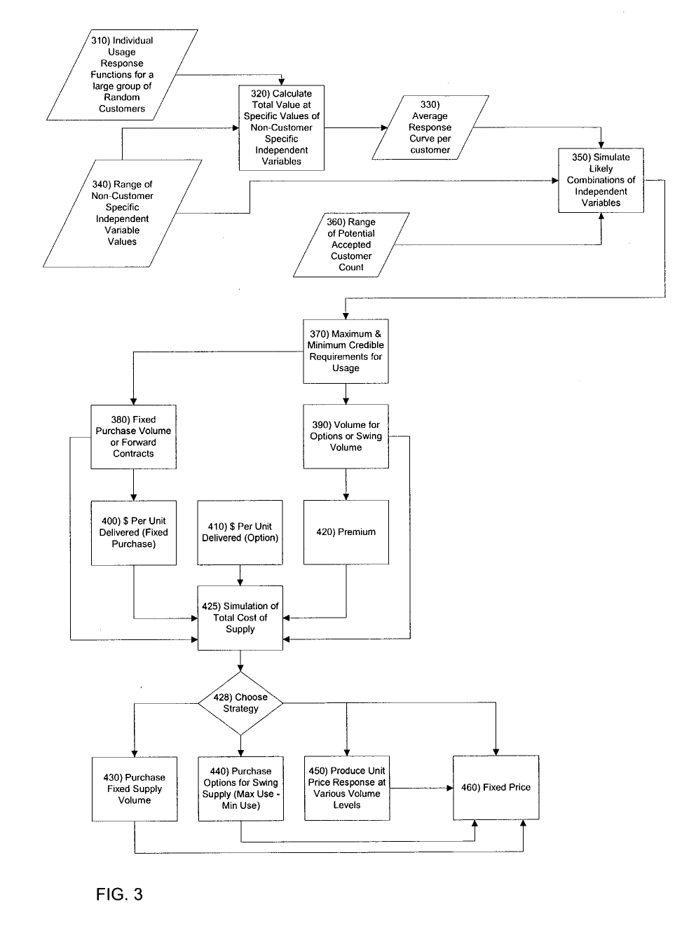

FIG. 3 is a flow diagram illustrating a method of producing a fixed unit energy price for use in calculating a capped energy bill according to one embodiment of the present invention. Individual usage response functions for a large group of random customers 310 are exercised using a range of non-customer specific independent variable values 340 to Calculate the total value at specific values of non-customer specific independent variables 320. The total value 320 is divided by the number of customers in the group to determine the average response curve per customer 330. The average response curve per customer 330 is exercised using the range of non-customer specific independent variable values 340 and the range of potential accepted customer count 360 to simulate likely combinations of usage 350. The results of the simulation are analyzed to determine the maximum and minimum credible requirements for usage 370. The steps utilized in producing maximum and minimum credible requirements for usage 370 may be done in various orderings. The results may be stored, for example, in the system database 180 or used immediately in subsequent steps.

Various combinations of fixed purchase volume or forward contracts 380 and volume for options or swing volume contracts 390 are analyzed. Different contract strikes for the options 390 and fixed purchase volume 380 yield different unit prices for the commodity delivered 400 and 410 and require different premiums 420. In general, the fixed and option volumes 380 and 390 may be chosen to cover all usage scenarios from minimum to maximum credible requirements 370. However, there may be instances when it is beneficial or prudent for the offeror to cover a wider or narrower range of usage. For example, a risk-averse offeror may cover a wider range of usage, while a risk-accepting offeror may self-absorb a portion of the risk and cover a narrower range of usage.

A simulation of total cost of supply 425 is performed at different volumes of usage specified in the simulation of likely combinations of usage 350 using prices for each of the various combinations of fixed purchase 380 and swing or options 390 and the resulting financial attributes 400, 410 and 420 that are set by the combinations of 380 and 390. The average unit cost of supply 450 at various volumes from the minimum to maximum credible requirements 370 is found by taking the total supply cost at that volume and dividing by the volume. For example, if the minimum volume is 10,000 units and the maximum volume is 20,000 units with pricing for a fixed volume of 10,000 units at $40,000, and the option premium is $20,000, and the purchase price for volume purchased under the option is $5.00 per unit, the total cost of purchasing 10,000 units would be $60,000 or $6.00 per unit. The total cost of purchasing 20,000 units would be $110,000, or $5.50 per unit. In another example, if the minimum volume is 10,000 units and the maximum volume is 20,000 units with pricing for a fixed volume of 10,000 units at $40,000, and the option premium is $10,000, and the purchase price for volume purchased under the option is $5.00 per unit, the total cost of purchasing 10,000 units would be $50,000, or $5.00 per unit. The total cost of purchasing 20,000 units would be $100,000, or $5.00 per unit. This example can be examined to show that the price is fixed from the minimum to maximum credible volumes.

In some instances, this simulation may be performed on a month-by-month basis over a period of time with financial instruments being exercised each month or it may be performed over a periodic basis with instruments being exercised once or more in the period.

A decision is made to choose a strategy 428 that supports the goals of the offeror. For instance, in the first case above, the offeror could make the capped bill offer to consumers based on the maximum unit price of the simulation $6.00. Should the usage place the offeror in a favorable unit cost position, the offeror will realize additional gains. Using the prices in the second example, the offeror could forego additional gains in favor of a lower offering price to consumers. In an alternate selection, the offeror could use a $5.50 price and take the risk of adverse effects caused by the usage volume. Another strategy is to select the flattest price from maximum to minimum consumption. Numerous other optimization goals and constraints could be used for this strategy process.

Once the strategy decision 428 has been made, the contracts are purchased for fixed supply volume 430 and options for swing supply 440. An alternative to purchasing the physical commodity is to mirror the transaction using financial instruments. The fixed unit price used to calculate the capped bill 460 is determined using the strategy chosen 428 and the unit price response at various volume levels 450 and the addition of any fees for risk managements determined by the offeror. The above tasks may be performed in a different order or with a slightly different methodology without changing the scope of the invention.

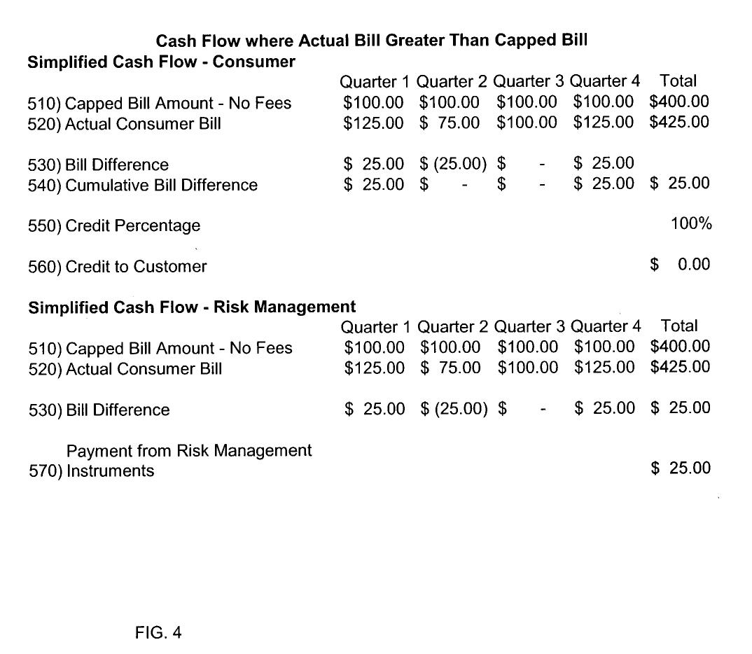

FIG. 4 represents cash flows to and from a consumer during the performance of a capped bill program when the total amount of the consumer's actual bill is greater than the total capped bill amount as well as the cash flows from the risk management instruments during the same period. For the sake of simplicity, the capped bill term is shown as a series of four quarterly payments, although it could consist of any number of payments agreed upon in the capped bill contract. In this example, the four payments are all part of a single capped bill period.

The capped bill amount 510 represents the amount the customer pays in each of the payment periods. The total of the capped bill amount 510 is the maximum amount the customer will pay for the capped bill during the capped bill program term. In this example, the capped bill amount 510 is constant over the four quarters and does not include fees. Fees may be included as a separate line item or may be bundled with the capped bill amount 510. In a different example, each quarter could represent a different capped bill period, and the associated capped bill amounts could vary. The actual consumer bill 520 is the actual amount of the consumer's bill during the same capped bill program term. The bill difference 530 is calculated by subtracting the capped bill amount 510 from the actual consumer bill 520. The cumulative bill difference 540 accumulates the individual bill differences 530. In the alternate example, the cumulative bill difference 540 would be accumulated over each capped bill period. Refund calculations would be made at the end of each capped bill period. In this example, at the end of the capped bill program the cumulative bill difference 540 is positive at the end of the capped bill program. Financial entities offering this product may use a payment from risk management instruments 570 to pay all, a part or more than the amount of the actual consumer bill 520 that exceeds the capped bill amount 510. In some cases however, the risk may be absorbed by the offeror. The payment from risk management instruments 570 may be remitted, for example, to a risk management contractor or directly to the supplier of the product covered by the capped bill program, such as a utility company in the case of a capped energy bill or a bank or mortgage company in the case of a borrowing.

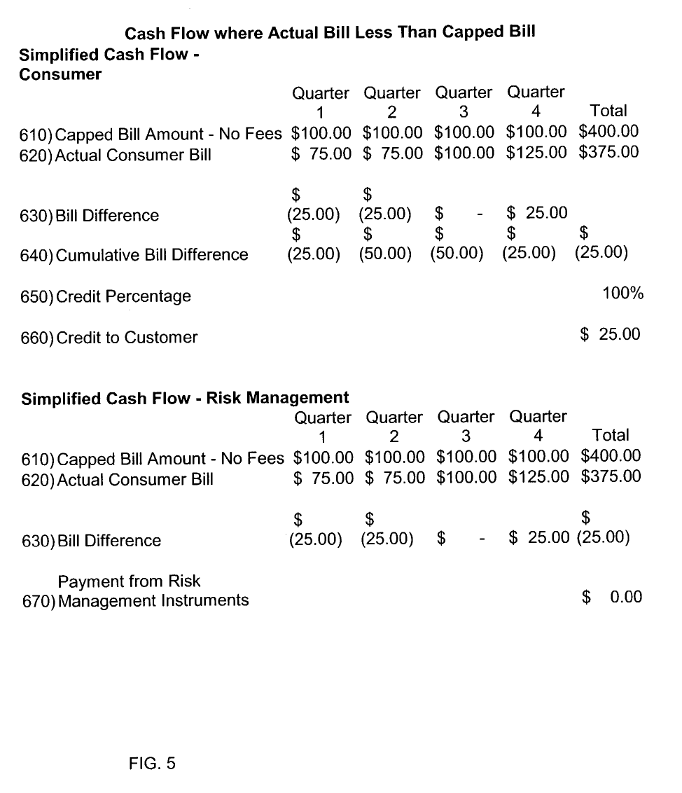

FIG. 5 represents the cash flows to and from the consumer during the performance of a capped bill program when the total amount of the consumer's actual bill is less than the total capped bill amount as well as the cash flows from the risk management instruments during the same period. For the sake of simplicity, the capped bill term is shown as a series of four quarterly payments, although it could consist of any number of payments agreed upon in the capped bill contract. In this example, the four payments are all part of a single capped bill period.

The capped bill amount 610 represents the amount a customer pays in each of the payment periods. The total of the capped bill amount 610 is the maximum amount the customer will pay for the capped bill during the capped bill program term. The actual consumer bill 620 is the actual amount of the consumer's bill during the same capped bill program term. The bill difference 630 is calculated by subtracting the capped bill amount 610 from the actual consumer bill 620. The cumulative bill difference 640 accumulates the individual bill difference 630. In this example the cumulative bill difference is negative. The total cumulative bill difference 640 is multiplied by the credit percentage 650. The resulting credit to customer 660 is then refunded to the customer. If the cumulative bill difference 630 is positive at the end of the capped bill program, this represents the payment from risk management instruments 670 that will pay the amount of the actual consumer bill 620 that exceeds the capped bill amount 610. The payment from risk management instruments 670 may be remitted, for example, to a risk management contractor or directly to the supplier of the product covered by the capped bill program, such as a utility company in the case of a capped energy bill or a bank or mortgage company in the case of a borrowing. As in the example in FIG. 5, there are numerous variations on capped bill periods that may be used.

In one embodiment of the present invention, the capped bill may be offered with an insurance component. In such an embodiment, a premium is paid that may be used, in whole or in part, to purchase risk management instruments. In various embodiments, the premium is paid by consumers, is embedded in the capped bill product, is paid by a provider such as a utility company or an energy provider, and/or is paid by a third party (e.g. an energy assistance agency). In exchange for the payment of the premium, a party or entity agrees to pay the excess bills over a specified dollar amount (i.e. a capped amount) for a covered period and/or the entity agrees to pay the excess product (e.g. energy) used over a capped amount (e.g. a capped payment, rate, or price that is capped at a predetermined amount) for the covered period.

In various embodiments, the payee, or beneficiary, of proceeds in the form of damages may be, for example, the consumer, a provider such as a utility company or an energy provider, or a third party such as a social agency. Thus, in one embodiment and by way of example, if a consumer pays quarterly bills of $125, $100, $150, and $100, and the consumer's quarterly bill is capped at $100 per quarter, the consumer (or a third party that paid the bills on behalf of the consumer) may receive a refund in the form of insurance proceeds from a risk management instrument or instruments in the amount of $75. Alternatively and in another embodiment, by way of example if the consumer's bills are capped at $100 per quarter and the consumer pays quarterly bills of $100 each quarter but the actual consumer bills per quarter were $125, $100, $150, and $100, the energy provider or a utility may receive a refund in the form of insurance proceeds from a risk management instrument or instruments in the amount of $75.

In one embodiment, the insurance proceeds may not cover the entire difference between the capped amount and the actual amount. For example, if a capped energy bill amount is set based on various factors, including consumer behavior and weather-related factors, and the consumer changes its behavior, the insurance proceeds may only cover a portion of the difference between the capped amount and the actual amount (i.e. the portion attributed to weather and not consumer behavior).

In various embodiments, the reporting and payment of losses pursuant to the insurance product may be made at various times. For example, payment and reporting may be made after a bill occurs, payment and reporting may be based on factors such as, for example, weather or energy prices coincident with a bill, and/or payment and reporting may be made in anticipation of a bill given factors such as, for example, weather or energy prices. Payment may be made, in various embodiments, coincident with a period in which bills are capped, after the capping period, or after a bill has been paid.

In one embodiment, the capped bill offer generation module 230 may determine the amount of premium that is to be paid in connection with the capped bill offering.

It can be understood that the systems and methods of the present invention may be implemented using, for example, any suitable type of computer hardware, software, or combination thereof. Such software may be coded in any suitable computer programming language such as, for example, C or C++ using, for example, conventional or object-oriented techniques.

Although the present invention has been described herein with reference to certain embodiments, numerous modifications and variations can be made and still the result will come within the scope of the invention. No limitation with respect to the specific embodiments disclosed herein is intended or should be inferred.

We claim:

1. A method of providing one of a good or a service to at least one entity at one of a payment, rate, or price that is capped at a pre-determined amount, comprising:
producing an offer for the entity, wherein the offer represents one of a capped maximum payment, a capped maximum rate, or a capped maximum price amount;
receiving an insurance premium;
providing the good or service to the entity at one of a payment, rate, or price that may fluctuate, wherein the payment, rate, or price cannot exceed the capped maximum payment, capped maximum rate, or capped maximum price amount; and
paying an insurance proceed when an actual price of the good or service exceeds the capped maximum payment, capped maximum rate, or capped maximum price amount.

2. The method of claim 1, wherein the insurance premium is received from one of the entity, a third party and a provider of the good or service.

3. The method of claim 1, wherein the insurance premium is included in the capped maximum payment, capped maximum rate or capped maximum price amount.

4. The method of claim 1, wherein the insurance proceed is paid to one of the entity, a provider of the good or service, and a third party.

5. The method of claim 1, wherein the entity is selected from the group consisting of a consumer, a broker, a marketer, an originator, an aggregator, and a wholesaler.

6. The method of claim 1, further comprising tracking one of an actual payment, an actual rate, or an actual price of the good or service.

7. The method of claim 1, further comprising tracking consumption of the good or service by the entity.

8. The method of claim 1, further comprising one of purchasing at least one risk management instrument and selling at least one risk management instrument.

9. The method of claim 1, further comprising purchasing at least one risk management instrument using at least a portion of the insurance premium.

10. The method of claim 1, wherein the good or service is selected from the group consisting of a money lending service and an energy product.

11. A capped bill calculation system, comprising:
a data input module in communication with a data storage medium for receiving data from at least one entity; and
a capped bill offer generation module for generating an offer, wherein the offer offers one of a good or a service at one of a payment, rate, and price that may fluctuate, wherein one of an actual payment, actual rate, and actual price of the good or service cannot exceed one of a maximum payment, a maximum rate, and a maximum price amount, and wherein the offer takes into account an insurance premium for insurance that is used to cover at least a portion of a difference between one of the maximum payment, the maximum rate, and the maximum price amount and one of the actual payment, the actual rate, and the actual price of the good or service when one of the actual payment, the actual rate, and the actual price of the good or service exceeds one of the maximum payment, the maximum rate, and the actual price amount.

12. The system of claim 11, wherein the data storage medium includes a database.

13. The system of claim 11, further comprising a risk module in communication with the data storage medium for developing a strategy for purchasing at least one risk instrument that is used to offset a risk associated with offering one of a good or service at one of a payment, a rate, and a price that is capped at one of a maximum payment, a maximum rate, and a maximum price amount.

14. The system of claim 13, wherein the risk module develops a strategy for purchasing at least one risk instrument using at least a portion of the insurance premium.

15. The system of claim 11, further comprising a data cleaning module in communication with the data storage medium for correcting inaccuracies relating to the data.

16. The system of claim 11, further comprising an acceptance tracking system in communication with the data storage medium for tracking whether the entity has accepted the offer.

17. The system of claim 11, further comprising a report generation module in communication with the data storage medium.

18. The system of claim 11, further comprising a reconciliation module in communication with the data storage medium.

19. The system of claim 11, wherein the risk module includes an individual risk module and an aggregate risk module.

20. The system of claim 11, wherein the good or service is selected from the group consisting of a money lending service and an energy product.

21. A computer-readable medium having stored thereon instructions which, when executed by a processor, cause the processor to:
produce an offer for an entity, wherein the offer represents one of a capped maximum payment, a capped maximum rate, or a capped maximum price amount;
receive an insurance premium;
provide one of a good or service to the entity at one of a payment, rate, or price that may fluctuate, wherein the payment, rate, or price cannot exceed the capped maximum payment, capped maximum rate, or capped maximum price amount;
pay an insurance proceed when an actual price of the good or service exceeds the capped maximum payment, capped maximum rate, or capped maximum price amount.

22. An apparatus, comprising:
means for producing an offer for an entity, wherein the offer represents one of a capped maximum payment, a capped maximum rate, or a capped maximum price amount;
means for receiving an insurance premium;
means for providing one of a good or service to the entity at one of a payment, rate, or price that may fluctuate, wherein the payment, rate, or price cannot exceed the capped maximum payment, capped maximum rate, or capped maximum price amount;
means for paying an insurance proceed when an actual price of the good or service exceeds the capped maximum payment, capped maximum rate, or capped maximum price amount.
